(19) United States
(12) Patent Application Publication
(10) Pub. No.: US 2011/0232095 A1
(43) Pub. Date: Sep. 29, 2011

(54) Carton cutter

(76) Inventor: Yong Kim, Phoenix, AZ (US)

(21) Appl. No.: 12/798,058

(22) Filed: Mar. 29, 2010

(51) Int. Cl. B67B 7/78; B65B 69/00

(52) U.S. Cl. 30/2; 53/492

(57) ABSTRACT

A device comprising a body having a back, two sides, and a bottom attached along edges to create a body that has open top and front sides. Located on the interior and extending between the two sides are a carton supporting shelf, a slide shelf and at least one, preferably two braces. Also attached to the interior is a carton shearing mechanism comprising a first cutting apparatus and a second cutting apparatus. The first cutting apparatus comprises a first pair of cutting blades, one attached to the back and one attached to a brace. The second cutting apparatus comprises a second pair of cutting blades, one attached to the slide shelf and one attached to a brace.

### FIELD OF THE INVENTION

The present invention relates to packaging and, more particularly, to an apparatus and method for cutting open cases containing goods.

### BACKGROUND

Beverages are produced in a factory, and they are packaged in various units to be sold to consumers. For example, prepackaged beverages in rectangular cartons are delivered by a distributor to retail stores, which include 6-pack, 12-pack, 18-pack and 30-pack cartons.

At retail establishments, the 6-pack, 12-pack, 18-pack and 30-pack cartons are a necessity. However, instead of ordering 6-pack, 12-pack, and 18-pack cartons from the distributors, retail stores often purchase 30-pack cartons and divide them to create the 6-pack, 12-pack, 18-pack cartons. By doing so, the retail stores buy the beverages from the distributor at the lowest price per unit.

At the retail stores, the 30-pack cartons may be manually opened and the contents are removed and repackaged into smaller allotments. For example, the upper, front, bottom and back sides of a 30-pack carton may be cut and separated into two distinct parts. Typically, when cutting these 30-pack cartons, a utility knife or other such sharp cutter is used together with a ruler. However, it is difficult to cut the cartons correctly at a desired position. Furthermore, a small misalignment of the cutter may lead to punctured product, creating unwanted wastage.

Accordingly, the above-mentioned box curing method is generally inefficient and costly, and creates unnecessary waste materials. The present invention aims to solve both of these problems by cutting each package exactly at desired positions, eliminating the unwanted wastage.

### SUMMARY OF THE INVENTION

It is an object of the present invention to provide a device for cutting open cases or cartons containing products. The device typically includes a body with a cutting mechanism. The cutting mechanism includes a first cutting apparatus comprising at least two first cutting devices adapted to cut open two first surfaces of the case and a second cutting apparatus comprises at least two second cutting devices adapted to cut two second surfaces of the case thereby separating two segments of the case from each other.

It is another object of the present invention to provide a method for cutting open a case of product. The method includes the steps of placing the case into the open top of the device. The carton is slide down into the body and onto the carton supporting shelf, past the first cutting apparatus, thereby slicing open a first pair of sides of the carton.

The carton is then tilted forward and urged down the slide shelf and onto the stop shelf, past the second cutting apparatus, thereby slicing open a second pair of sides of the carton. If the first and second cutting apparati are properly aligned, the carton has now been sliced open along a continuous line on four of its sides, thereby allowing the two halves to be separated.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiment is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the device of the present invention.

FIG. 2 is a cut-away view of the device illustrating the placement of the cutting apparati.

FIG. 3 is a side view illustration of the use of the device.

FIG. 4 is a perspective cut-away view of the illustrating insertion of a carton into the device.

FIG. 5 is a perspective cut-away view of the illustrating the first surfaces after the first incision by the device.

FIG. 6 is a perspective cut-away view of the illustrating the second surfaces after the second incision by the device.

FIG. 7 illustrates the portion separator of the present invention.

FIG. 8 illustrates the storage position of the portion separator of the present invention.

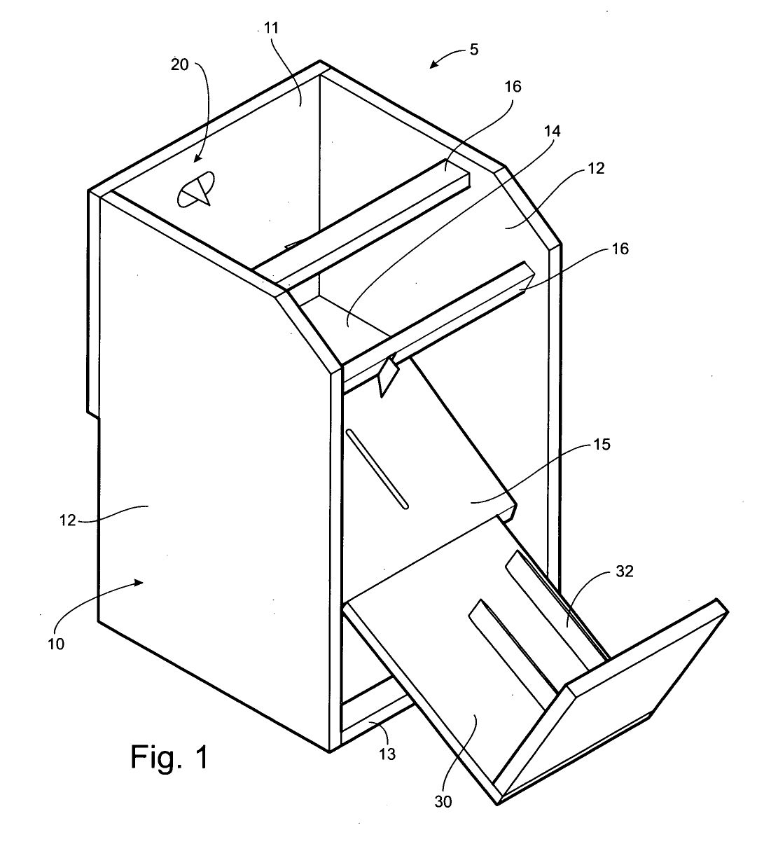

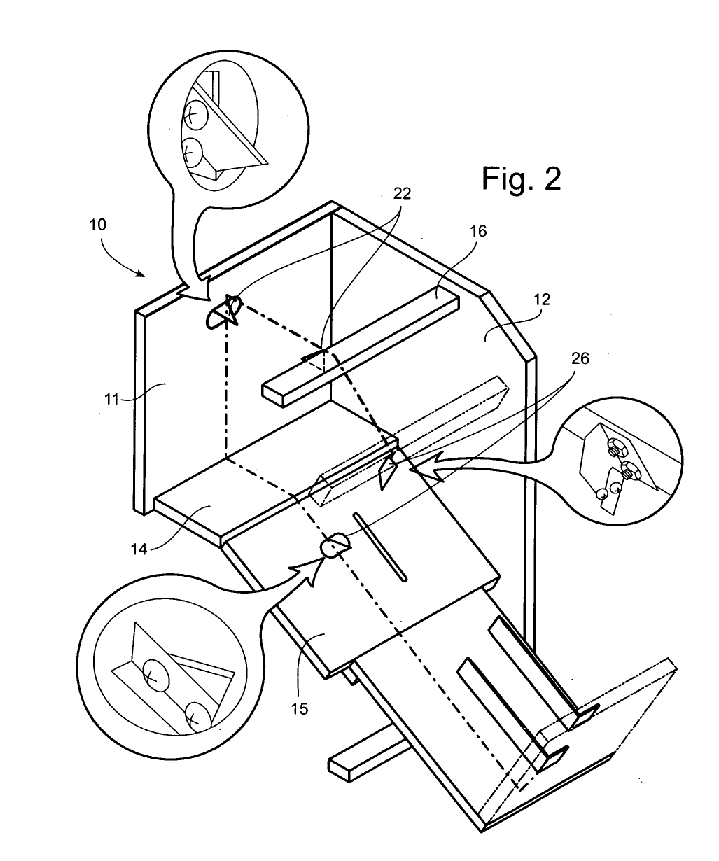

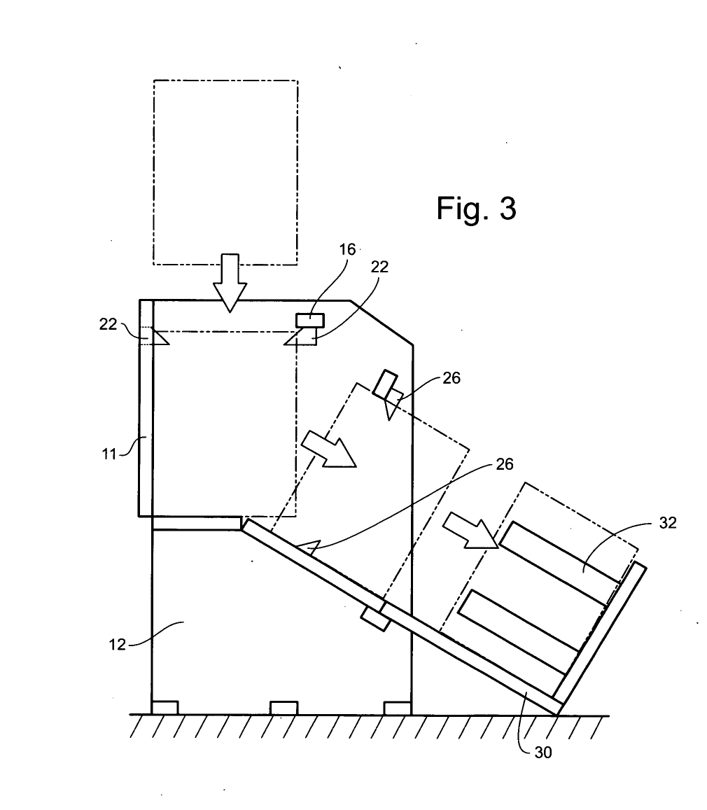

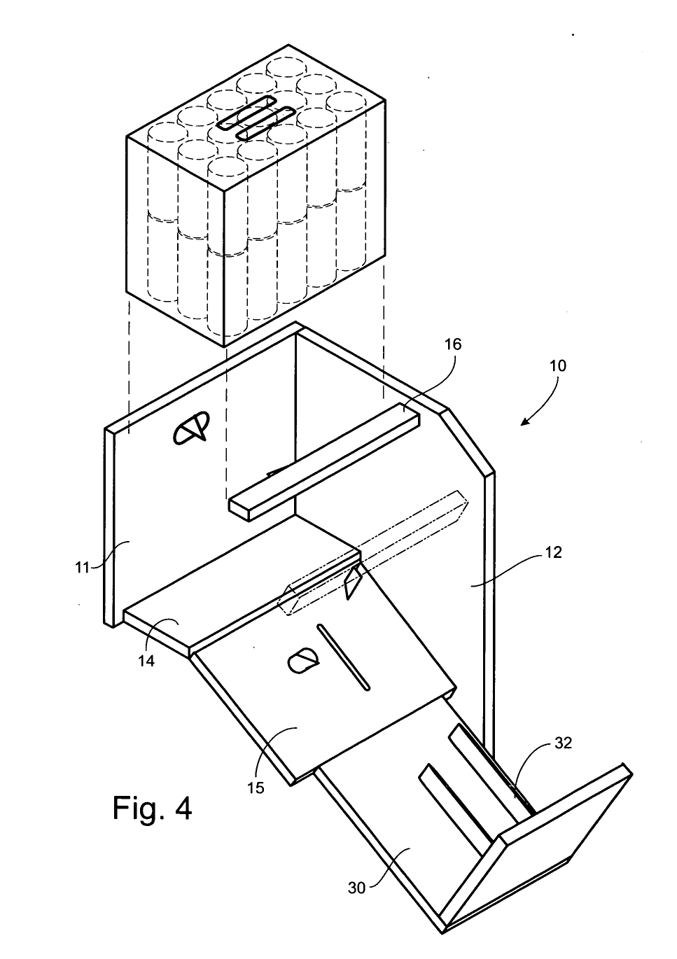

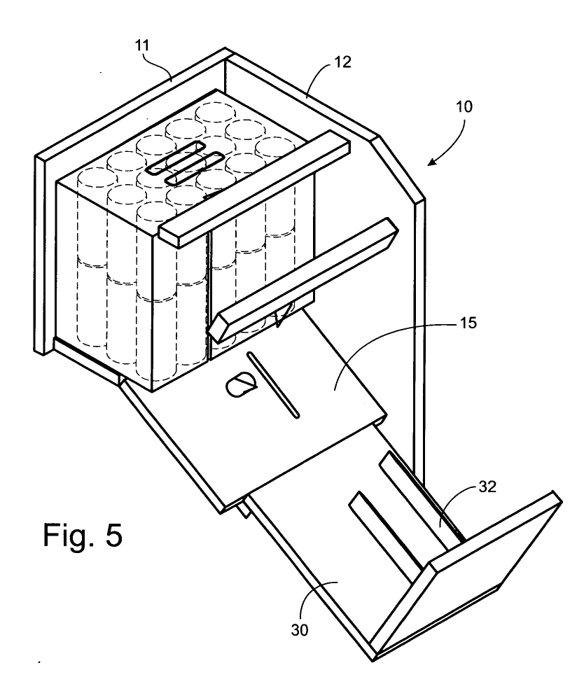

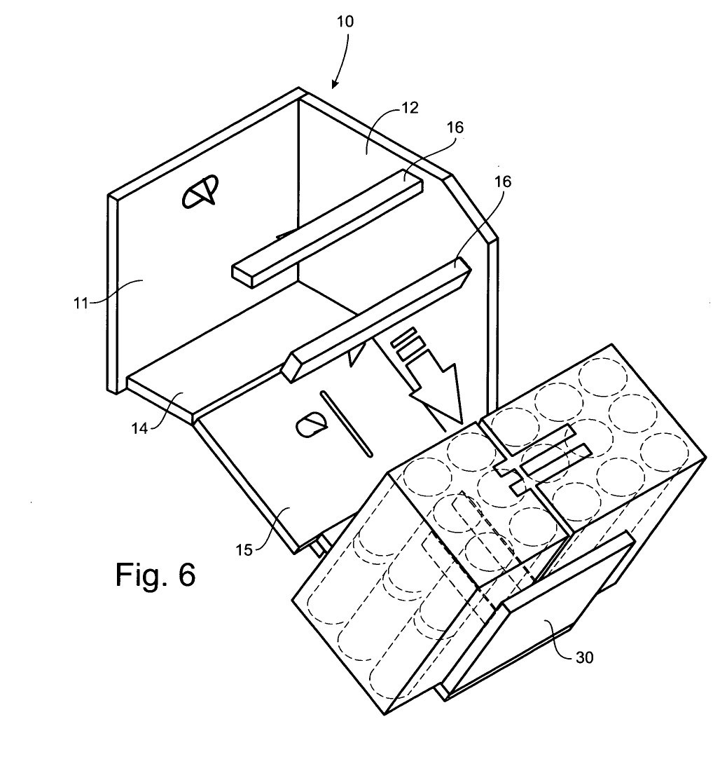

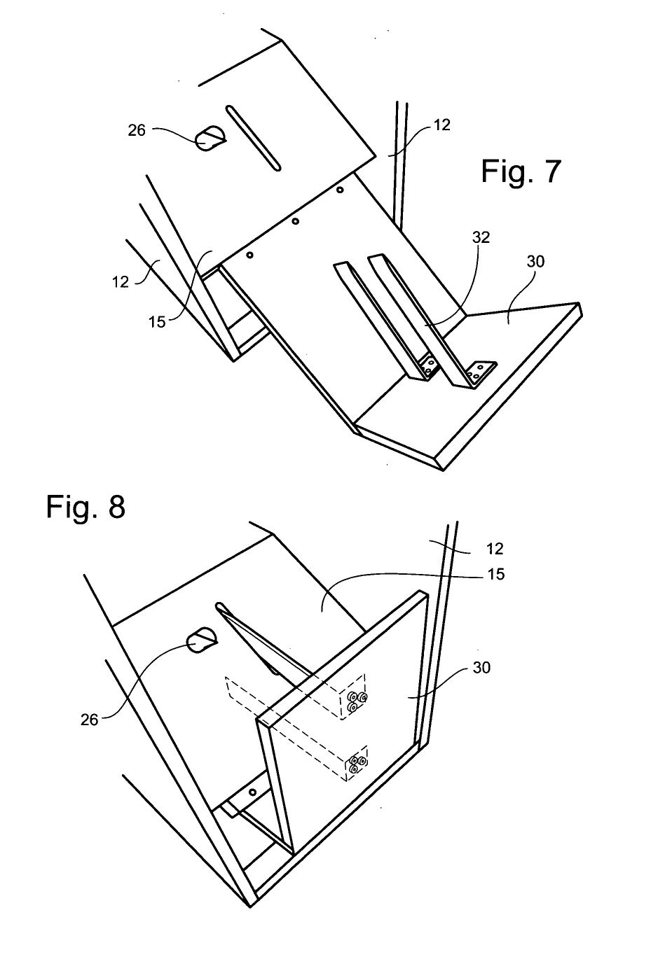

### DESCRIPTION OF PREFERRED EMBODIMENT

With reference to the drawings and in operation, the present invention provides an apparatus and method for cutting open a case of product.

The device 5 according to the present invention comprises a carton receiving body, generally 10, The body, in one embodiment, has a back 11, two sides 12, and a bottom 13. These are all attached to each other along edges to create a body 10 that has open top and front sides. Located on the interior of the device 5, and extending between the two sides 12 are a carton supporting shelf 14, a slide shelf 15 and at least one, preferably two braces 16.

Attached to the interior of the device 5 is a carton shearing mechanism 20. The preferred carton shearing mechanism 20 comprises a first cutting apparatus 22 and a second cutting apparatus 26.

The preferred first cutting apparatus comprises a first pair of cutting blades, one attached to the back 11 and one attached to a brace 16. The cutting blade that is attached to the back 11 is preferably attached to an outside surface of the back 11 and extends through an aperture in the back 11 thereby allowing only a small, adjustable, amount of the cutting blade to extend past the inside surface of the back. In this way, a variety of cartons with different thickness may be opened without marring the products contained therein. The cutting blade that is attached to the brace 16 is preferably attached to an underside of the brace 16 such that only a small, adjustable, amount of the cutting blade extends past a rear surface of the brace 16.

The preferred second cutting apparatus comprises a second pair of cutting blades, one attached to the slide shelf 15 and one attached to a brace 16. The cutting blade that is attached to the slide shelf 15 is preferably attached to a bottom surface of the slide shelf 15 and extends through an aperture in the slide shelf 15 thereby allowing only a small, adjustable, amount of the cutting blade to extend past the upper surface of the slide shelf. In this way, a variety of cartons with different thickness may be opened without marring the products contained therein. The cutting blade that is attached to the brace 16 is preferably attached to a front side of the brace 16 such that only a small, adjustable, amount of the cutting blade extends past a bottom surface of the brace 16.

In a preferred embodiment, the position of all of the cutting blades are adjustable so that a variety of differently sized cartons may be divided at a variety of different points.

In the preferred embodiment, the slide shelf 15 is angled relative to the carton supporting shelf 14. However, it may not be angled and still fall within the scope of the present invention. The slide shelf 15 further includes a separator receiving slot approximately in the middle of the shelf 15.

In addition to the body 10, the device 5 further comprises a stop shelf 30. The stop shelf 30 is basically an L shaped shelf that is attached to the body 10 in a coplanar configuration with the slide shelf 15 in order to receive the opened carton in preparation for separation of the two halves. The stop shelf 30 further comprises at least one, preferably two portion separators 32. These portion separators 32 are used in order to separate the products contained within the cartons and aid in the separation of the two halves.

In use a carton or case, is placed into the open top of the device 5. The carton is slide down into the body 10 and onto the carton supporting shelf 14, past the first cutting apparatus 22, thereby slicing open a first pair of sides of the carton. The carton is then tilted forward and urged or pushed down the slide shelf 15 and onto the stop shelf 30, past the second cutting apparatus 26, thereby slicing open a second pair of sides of the carton. If the first and second cutting apparati are properly aligned, the carton has now been sliced open along a continuous line on four of its sides, thereby allowing the two halves to be separated.

In one preferred embodiment, the stop shelf 30 includes the portion separator 32. This is useful for cartons containing items such as cans and the like, as the portion separator 32 holds portion in one half of the carton while the other half is moved to a remote location. If the stop shelf 30 includes the portion separators 32, these portion separators 32 are inserted into the carton as it is being slid onto the stop shelf 30 thereby effectively separating the products contained within the carton into two separate portions. To store the device 5, the stop shelf 30 is removed from its coplanar position with the slide shelf 15 and the long leg of the L shape is inserted into an aperture sized to receive a portion of the stop shelf 30 located under the slide shelf 15. If portion separators 32 are attached to the short leg of the stop shelf 30, at least one may be inserted into a slot located in the slide shelf 15. Any remaining portion separators 32 may be inserted into the aperture located under the slide shelf. This, then, allows for compact storage of the device.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A device for opening cartons comprising:
a) a body comprising a back, two sides and a bottom, all attached to each other to define a body with an open top and front;
b) the body further comprising a carton supporting shelf, a slide shelf and at least one brace, each of which extends between the two sides;
c) at least two pairs of cutting blades attached to the body such that a small portion of the each cutting blade projects into the interior of the body;
d) where a first pair of blades has one blade projecting past the interior surface of the back of the body and the other blade projecting past the rear surface of a brace; and
e) where a second pair of blades has one blade projecting past a top surface of the slide shelf and the other blade projecting past a bottom surface of a brace.

2. The device according to claim 1 further comprising a separate L shaped stop shelf that may be attached to the body in a coplanar configuration with the slide shelf.

3. The device according to claim 2 where the stop shelf further comprises at least one portion separator and the slide shelf.

4. The device according to claim 1 where the slide shelf further comprises a portion separator receiving slot located in position to allow insertion of the portion separator when the stop shelf is in a stored position.

5. The device according to claim 3 where the slide shelf further comprises a portion separator receiving slot located in position to allow insertion of the portion separator when the stop shelf is in a stored position.

6. The device according to claim 1 where the blade that extends past the interior surface of the back, extends through an aperture and the blade that extends past the top surface of the slide shelf extends through a second aperture.

7. The device according to claim 6 further comprising a separate L shaped stop shelf that may be attached to the body in a coplanar configuration with the slide shelf.

8. The device according to claim 7 where the stop shelf further comprises at least one portion separator and the slide shelf.

9. The device according to claim 8 where the slide shelf further comprises a portion separator receiving slot located in position to allow insertion of the portion separator when the stop shelf is in a stored position.

10. A method for opening a carton comprising:
a) providing a carton opening device comprising
i. a body comprising a back, two sides and a bottom, all attached to each other to define a body with an open top and front;
ii. the body further comprising a carton supporting shelf, a slide shelf and at least one brace, each of which extends between the two sides;
iii. at least two pairs of cutting blades attached to the body such that a small portion of the each cutting blade projects into the interior of the body;
iv. where a first pair of blades has one blade projecting past the interior surface of the back of the body and the other blade projecting past the rear surface of a brace; and
v. where a second pair of blades has one blade projecting past a top surface of the slide shelf and the other blade projecting past a bottom surface of a brace;
b) providing a carton to be opened;
c) sliding the carton into the body of the device onto the carton supporting shelf, past the first pair of cutting blades;
d) tilting the carton forward and sliding it down the slide shelf past the second pair of cutting blades; and
e) separating the cut carton.

11. The method according to claim 10 wherein the device further includes a separate L shaped stop shelf that may be attached to the body in a coplanar configuration with the slide shelf.

12. The method according to claim 11 further including the step of sliding the cut carton onto the stop shelf prior to the step of separating the cut carton.

13. The method according to claim 12 wherein the stop shelf further includes at least one portion separator.

14. The method according to claim 13 including the step of inserting the portion separators into the carton as it is being slid onto the stop shelf.
